(19) United States
(12) Patent Application Publication
(10) Pub. No.: US 2015/0192764 A1
(43) Pub. Date: Jul. 9, 2015

(54) CONFOCAL MICROSCOPE

(71) Applicant: CANON KABUSHIKI KAISHA, Tokyo (JP)

(72) Inventor: Hideki Morishima, Utsunomiya-shi (JP)

(21) Appl. No.: 14/590,180

(22) Filed: Jan. 6, 2015

(30) Foreign Application Priority Data
Jan. 8, 2014 (JP) 2014-001690

(51) Int. Cl. G02B 21/00

(52) U.S. Cl. CPC G02B 21/008; G02B 21/0052

(57) ABSTRACT

The confocal microscope includes a first pinhole array provided with multiple first pinholes, an illumination optical system configured to introduce multiple light fluxes after passing through the multiple first pinholes to a sample, a condensing optical system configured to condense each of the multiple light fluxes from the sample, a second pinhole array provided with multiple second pinholes through which the multiple light fluxes from the condensing optical system respectively pass, and a light-receiving element configured to receive the multiple light fluxes after passing through the multiple second pinholes. The light-receiving element is disposed at a position distant, by a first distance, from each of the second pinholes or from a conjugate point of each of the second pinholes and is configured to receive, at multiple pixels, each of the light fluxes after passing through the second pinholes.

### BACKGROUND OF THE INVENTION

1. Field of the Invention

The present invention relates to a confocal microscope using pinholes.

2. Description of the Related Art

Confocal microscopes introduce an illumination light after passing through a first pinhole to a sample through an illumination optical system which condenses the light, condense the light reflected by or transmitted through the sample by an imaging optical system toward a second pinhole and causes only light after passing through the second pinhole to be received by a light-receiving element to produce an image. Such confocal microscopes have a higher resolution compared to those of typical microscopes and are capable of acquiring sectional images of the sample by their sectioning effect in a depth direction, so that they are used in a variety of fields. In the confocal microscope, the first pinhole, a light-condensing point on the sample and the second pinhole have a conjugate relation with one another, so that it is necessary for producing an image of the entire sample to entirely scan the sample with the light-condensing point formed on the sample. The scan of the sample is performed by, for example, using a galvanometer scanner that uses two galvanomirrors as disclosed in Japanese Patent Laid-Open No. 2000-098241 or rotating a so-called Nipkow disk as disclosed in Japanese Patent Laid-Open No. 2009-210889.

However, the method of performing the scan by using the galvanometer scanner scans all surfaces of the sample while sequentially acquiring pixel signals each corresponding to one light-condensing point on the sample and thus requires a long period of time to produce the image of the entire sample.

On the other hand, the method of performing the scan by using the Nipkow disk simultaneously forms a large number of light-condensing points on the sample and thereby can simultaneously acquire the pixel signals corresponding to the light-condensing points. However, this method causes a light after passing through one pinhole to image on a small number of pixels located on a light-receiving element and thus often causes color shift in producing a color image.

### SUMMARY OF THE INVENTION

The present invention provides a confocal microscope capable of shortening a period of time for scan and of producing images with a good image quality.

The present invention provides as an aspect thereof a confocal microscope including a first pinhole array provided with multiple first pinholes, an illumination optical system configured to introduce multiple light fluxes after passing through the multiple first pinholes to a sample, a condensing optical system configured to condense each of the multiple light fluxes from the sample, a second pinhole array provided with multiple second pinholes through which the multiple light fluxes from the condensing optical system respectively pass, and a light-receiving element configured to receive the multiple light fluxes after passing through the multiple second pinholes. The light-receiving element is disposed at a position distant, by a first distance, from each of the second pinholes or from a conjugate point of each of the second pinholes and is configured to receive, at multiple pixels, each of the light fluxes after passing through the second pinholes.

Other aspects of the present invention will become apparent from the following description and the attached drawings.

### BRIEF DESCRIPTION OF THE DRAWINGS

FIG. 1 is a schematic diagram illustrating a configuration of a confocal microscope that is Embodiment 1 of the present invention.

FIG. 2 explains a light-receiving element of the confocal microscope of Embodiment 1.

FIG. 3 is a schematic diagram illustrating a configuration of a confocal microscope that is Embodiment 2 of the present invention.

FIG. 4 is a schematic diagram illustrating a configuration of a confocal microscope that is Embodiment 3 of the present invention.

### DESCRIPTION OF THE EMBODIMENTS

Exemplary embodiments of the present invention will be described below with reference to the attached drawings.

First of all, prior to describing specific embodiments, technical items common in the embodiments will be described.

A confocal microscope of each embodiment includes a first pinhole array provided with multiple first pinholes, an illumination optical system that introduces multiple light fluxes after passing through the multiple first pinholes to a sample, and a condensing optical system that condenses each of the multiple light fluxes from the sample. The confocal microscope of each embodiment further includes a second pinhole array provided with multiple second pinholes through which the multiple light fluxes from the condensing optical system respectively pass and a light-receiving element that receives the multiple light fluxes after passing through the multiple second pinholes.

Condensing, on the sample by the illumination optical system, the multiple light fluxes after passing through the multiple first pinholes provided to the first pinhole array enables forming, on the sample, multiple light-condensing points corresponding to the multiple light fluxes. A light flux as a response light from the sample (a reflected light, a transmitted light, fluorescent rays from the sample or the like) at each light-condensing point is condensed by the condensing optical system toward the second pinhole of the second pinhole array corresponding to the first pinhole through which the light flux has passed. Thereafter, the multiple light fluxes after passing through the multiple second pinholes are received by the light-receiving element, such as a CCD sensor or a CMOS sensor, including a large number of pixels. The light-receiving element is disposed at a position distant by a first distance (predetermined distance) from each of the second pinholes and from a conjugate point of each of the second pinholes. This arrangement causes the light fluxes after passing through the second pinholes to enter the light-receiving element with a spread theretoward and are received by the multiple pixels.

The confocal microscope of each embodiment thus configured relatively scans the first and second pinholes and the sample to produce an image of the entire sample.

As described above, in each embodiment, disposing the light-receiving element at the position distant from the second pinholes and the conjugate points to the second pinholes by the first distance provides, to each light flux passing through each second pinhole toward the light-receiving element, a spread depending on the first distance. The spread of the light flux and the first distance on which the spread is depended are set such that each light flux after passing through the second pinhole is received by a sufficiently large number of the pixels of the light-receiving element.

For instance, when NA22 represents an NA (numerical aperture) of each light flux condensed by the condensing optical system toward each second pinhole, L represents the first distance from each second pinhole or the conjugate point thereto to the light-receiving element, and p represents a pixel pitch of the light-receiving element, these values and a number N of pixels that receive the light flux after passing through the second pinhole on the light-receiving element are in a relation represented by following expression (1). Use of expression (1) enables calculating the above-mentioned first distance L for a desired number N of the pixels.

N=π·[(L·NA22)/p]² (1)

In addition, providing color filters that selectively transmit lights having mutually different wavelength ranges (for example, R, G and B) to the multiple pixels that receive each light flux after passing through the second pinhole and having the spread enables producing a color image. If the spread of each light flux is sufficiently large and thereby the number of the pixels that receive the light flux is sufficiently large, it is possible to cause the light flux as the response light to uniformly enter the multiple pixels to which the color filters for the wavelengths R, G and B are provided. This uniform entrance of the light flux enables producing pixel signals for the respective colors that are faithful to a wavelength distribution of the response light, which makes it possible to produce a good color image with less color shift.

Furthermore, in each embodiment, it is desirable that a sample-side field angle of the condensing optical system be large to the extent possible so as to increase a size of the sample whose image can be captured at a time. For instance, a biological sample used in pathological diagnosis typically has a size of approximately 15 mm by 15 mm and has a maximum size of approximately 20 mm by 20 mm. Therefore, it is desirable that the condensing optical system have a field angle is sufficiently large to cover the sample whose size is at least 15 mm by 15 mm. This setting enables, in many cases, forming a large number of light-condensing points for the entire sample, which makes it possible to minimize a relative scan between the sample and the first and second pinholes. Furthermore, if the condensing optical system has a sufficiently large field angle to cover a sample whose size is 20 mm by 20 mm, it is possible to produce images of most biological samples with a minimum scan.

The specific embodiments of the present invention will be described below.

### Embodiment 1

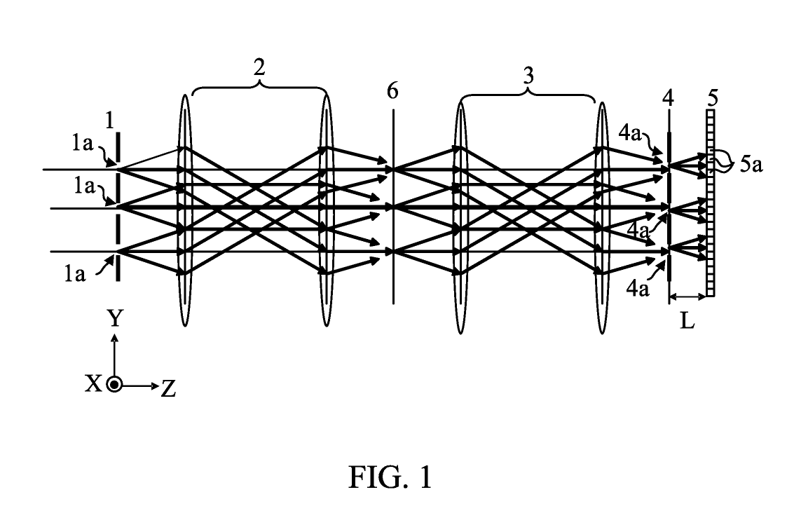

FIG. 1 illustrates a configuration of the confocal microscope that is a first embodiment (Embodiment 1) of the present invention. In FIG. 1, light fluxes are introduced by a light source (not illustrated) and a preliminary optical system to a first pinhole array 1. Multiple illumination lights (light fluxes) after passing multiple first pinholes 1a of the first pinhole array 1 are condensed by an illumination optical system 2 on a sample 6 and form multiple light-condensing points thereon. From each of the multiple light-condensing points formed on the sample 6, a response light (light flux) from the sample 6 is emitted. Each of the multiple response lights emitted from the multiple light-condensing points is condensed by a condensing optical system 3 toward a second pinhole 4a of a second pinhole array 4 corresponding to the first pinhole 1a through which the illumination light that is source of the response light have passed. Each of the response lights after passing through the second pinholes 4a enters a light-receiving element 5 disposed at a position distant from the second pinhole 4a (i.e., the second pinhole array 4) by a first distance L. The first pinhole 1a and the second pinhole 4a are in a conjugate relation by the illumination optical system 2 and the condensing optical system 3.

In this embodiment, the sample 6 mounted on a stage is scanned by a scanner not illustrated in FIG. 1, for example, a stage-driving mechanism in x, y and z directions. This configuration produces a confocal image as an image of the entire sample 6.

The light-receiving element 5 includes a large number of pixels. The response light after passing through each second pinhole 4a of the second pinhole array 4 travels, while being spread, toward the light-receiving element 5 disposed at the position distant from the second pinhole array 4 by the distance L as illustrated in FIG. 1 and enters the multiple pixels located on the light-receiving element 5. As a result, pixel signals are provided from the multiple pixels of the light-receiving element 5.

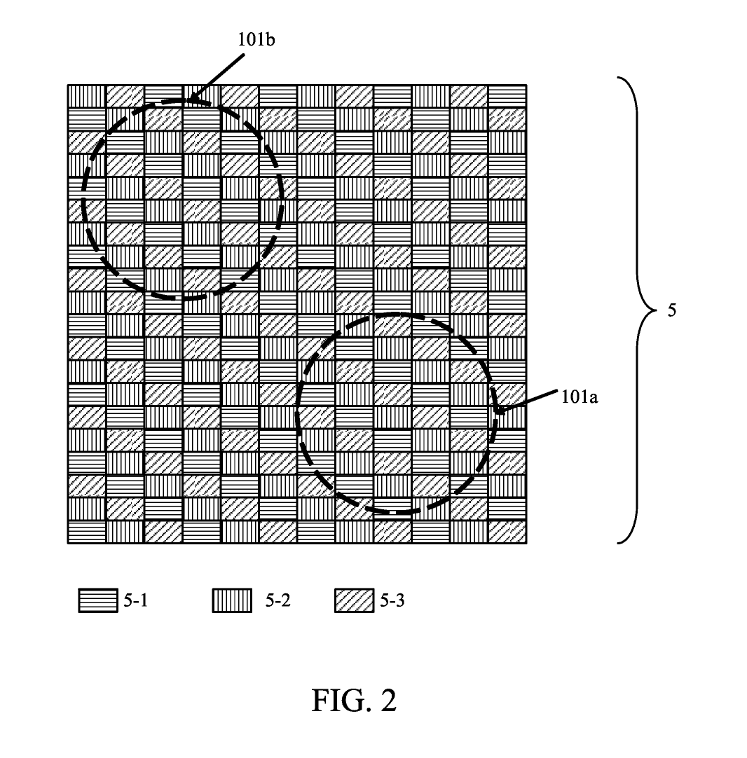

FIG. 2 illustrates part of the light-receiving element 5 viewed from a direction in which the response lights enter the light-receiving element 5 and spreads of the response lights entering multiple pixels on the light-receiving element 5. On the light-receiving element 5, pixels 5-1, 5-2 and 5-3 respectively including three types (R, G and B) of color filters (hereinafter respectively referred to as “R pixels 5-1”, “G pixels 5-2” and “B pixels 5-3”) are arranged in a Bayer array. In FIG. 2, reference numerals 101a and 101b denote spread ranges of the response lights on the light-receiving element 5; the response lights have passed through the mutually different second pinholes 4a.

Setting the distance L sufficiently long enables setting the spread ranges 101a and 101b of the response lights on the light-receiving element 5 such that the spread ranges 101a and 101b each include sufficient numbers of the R, G and B pixels 5-1, 5-2 and 5-3. An insufficiently sized spread range of the response light makes the number of any of the R, G and B pixels 5-1, 5-2 and 5-3 included in that spread range smaller than those of the other pixels, which causes problems such as the color shift (discoloration) in a produced color image.

Referring to FIG. 1, description will now be made of definitions of and basic relations among optical parameters in this embodiment. The following description is common in the other embodiments described later.

In this embodiment, NA11 represents an entrance-side NA of the illumination optical system 2, NA12 represents an exit-side NA of the illumination optical system 2, NA21 represents an entrance-side NA of the condensing optical system 3, and NA22 represents an exit-side NA of the condensing optical system 3. Moreover, m1 represents an imaging magnification of the illumination optical system 2 from the first pinhole 1a to the sample 6, and m2 represents an imaging magnification of the condensing optical system 3 from the sample 6 to the second pinhole 4a.

Furthermore, r1 represents a radius (first pinhole radius) of each first pinhole 1a, r2 represents a radius (second pinhole radius) of each second pinhole 4a, and r0 represents a radius of a pinhole image formed on the sample 6 by the light emerging from the first pinhole 1a and passing through the illumination optical system 2.

In addition, s1 represents a center-to-center distance (first pinhole pitch) between two mutually adjacent first pinholes 1a in the first pinhole array 1, s2 represents a center-to-center distance (second pinhole pitch) between two mutually adjacent second pinholes 4a in the second pinhole array 4, and s0 represents a distance between two mutually adjacent light-condensing points (adjacent spots) among the multiple light-condensing points formed on the sample 6.

It is apparent that the optical parameters have the following relations.

NA11/NA12=m1 (2)

NA21/NA22=m2 (3)

r0=r1·m1 (4)

s0=s1·m1 (5)

s2=m1·m2·s1=s0·m2 (6)

In these relations, the second pinhole radius r2 is regarded as identical to a radius of the pinhole image formed on the second pinhole array 4 by the light from the first pinholes 1a passing through the illumination optical system 2 and the condensing optical system 3. Moreover, the exit-side NA of the illumination optical system 2 is regarded as identical to the entrance-side NA of the condensing optical system 3. Thereby, the following relations are established:

NA12=NA21=NA11/m1=NA22·m2 (7)

r2=r1·m1·m2=r0·m2 (8)

As described above, the distance L between the second pinhole 4a and the light-receiving element 5, the pixel pitch p of the light-receiving element 5 and the number N of the pixels included in the spread range of the response light on the light-receiving element 5 have the following relation:

N=π·[(L·NA22)/p]² (1)

Therefore, it is desirable to set the distance L as long as possible such that a largest possible number N of the pixels are included in the spread range of each response light in order to prevent the color shift. However, excessively large-sized spread ranges of the respective response lights causes the spread ranges of the response lights from two mutually adjacent second pinholes 4a to partially overlap each other, which may cause crosstalk.

For this reason, this embodiment provides two conditions for setting the first and second pinhole pitches s1 and s2:

(a) the response lights (that is, the spread ranges thereof) from the two mutually adjacent second pinholes 4a do not overlap each other on the light-receiving element 5; and

(b) two mutually adjacent light-condensing points on the sample 6 do not overlap each other.

To satisfy the condition (a), it is necessary and sufficient that the second pinhole pitch s2 is larger than twice of a radius r6 of each illumination light on the sample 6. This condition is expressed as:

s2>2·NA22·L (9)

The condition (b) will be described. If aberrations of the illumination optical system 2 and the condensing optical system 3 are sufficiently reduced, the second pinhole radius r2 is often set from shape of an Airy disk depending on N22 which is the exit-side NA of the condensing optical system 3. For instance, the second pinhole radius r2 is often set to a radius at which an intensity of the light from a center peak of the Airy disk.

This setting corresponds to that, when r2 is defined as follows:

r2=k2·λ/NA22 (10)

k2 is set as a constant of 0.51. In expression (10), λ represents a wavelength of the illumination light (light flux). Although the constant k2 may be slightly changed depending on cases, the second pinhole radius r2 in this embodiment is fixedly set with k2 being 0.51.

When the second pinhole radius r2 is set using expression (10) with k2 being 0.51, condition (b) is expressed, with consideration of expressions (2) to (8), as follows:

s0=s2/m2>2·r0

2·r0=2·r2/m2

=2·k2·λ/(NA22·m2)

=2·k2·λ/NA21

=2·k2·λ/NA12

Therefore, to satisfy condition (b), it is enough to satisfy the following condition:

s2>2·k2·λ/NA22 (11)

A condition for making the color shift difficult to be generated is set to that the spread range of each response light from the second pinhole 4a on the light-receiving element 5 includes 300 or more pixels in total constituted by the R, G and B pixels 5-1, 5-2 and 5-3 (i.e., 100 or more pixels per color pixel group). This condition requires that, in each of the color pixel groups, a possibility of failing to provide a good pixel signal from one pixel be within 1% or less.

According to expression (1), this condition is equivalent to that a radius (spread radius) w of the spread range of each response lights on the light-receiving element 5 approximately satisfies the following relation (hereinafter referred to as “condition (c)”):

w>10·p

Next, a numerical example will be described in which the pixel pitch (pixel size) of the light-receiving element 5 is 5 μm, NA12=NA21=0.6, the wavelength λ=0.55 μm, and m1=1/m2. A minimum value of the second pinhole pitch s2 and other parameters will be shown in Table 1 which are set so as to satisfy conditions (a) and (b) in the above case when the distance L is set such that condition (c) is satisfied for eight values of the imaging magnification m2.

For instance, when the imaging magnification m2 is set to 10 times (expression (2)), the distance L that satisfies condition (c) is approximately 814 μm.

When the distance L is changed so as to satisfy condition (c), a value of the right side of expression (9) expressing condition (a) becomes, at approximately 98 μm, independent of the imaging magnification. Thus, the condition (b) will now be verified for a case where the second pinhole pitch s2 depending on condition (a) has a fixed value of approximately 98 μm.

Since NA22 that is the exit-side NA of the condensing optical system 3 is variable depending on the imaging magnification m2, expression (11) expressing condition (b) depends on the imaging magnification.

When the second pinhole pitch s2 is set to approximately 98 μm from condition (c), a distance between the two mutually adjacent light-condensing points (spots) on the sample 6 is 98 μm/m2. On the other hand, when NA12 that is the exit-side NA of the illumination optical system 2 and NA21 that is the entrance-side NA of the condensing optical system 3 are each fixed to 0.6, the radius of each light-condensing point on the sample 6 becomes a fixed value of 0.47 μm. When the imaging magnification m2 is smaller than a certain value, a value acquired by converting the second pinhole pitch s2 that is 98 μm into a distance on the sample 6 is larger than a value of condition (b) defined as twice of the radius of each light-condensing point on the sample 6. For this reason, condition (a) is a constraint. On the other hand, when the imaging magnification m2 is larger than the certain value, a value acquired by converting the second pinhole pitch s2 that is 98 μm into the distance on the sample 6 is smaller than twice of the radius of each light-condensing point on the sample 6. Thereby, the second pinhole pitch s2 is consequently defined by condition (b). Also in this case, since the value of the distance L is set in accordance with condition (c), the radius of the spread range of each response light on the light-receiving element 5 is 49 μm, which satisfies condition (c).

As described above, this embodiment enables, by setting the distance L between the multiple second pinholes 4a and the light-receiving element 5 to the first distance, causing the light flux from each of the second pinholes 4a to enter a sufficient number of the multiple pixels on the light-receiving element 5. Accordingly, this embodiment enables, by providing mutually different color filters to the multiple pixels, providing a confocal image with less color shift.

FIG. 1 conceptually illustrates the configuration of the confocal microscope, and thus the entrance-side NA and the exit-side NA of the illumination optical system 2 and the entrance-side NA and the exit-side NA of the condensing optical system 3 are seemingly identical to each other, respectively. However, these NAs are actually different from each other because the imaging magnification of the illumination optical system 2 and that of the condensing optical system 3 are each not 1×.

Moreover, although this embodiment has described the confocal microscope using transmission illumination, configurations and condition same as or modified from those in this embodiment are applicable also to a confocal microscope using epi-illumination.

Furthermore, although this embodiment has described the case of relatively scanning the sample 6 and the first and second pinhole arrays 1 and 4 by using the stage-driving mechanism, it is also possible to rotate, at high speed and in a synchronized manner, the first and second pinhole arrays 1 and 4 each using a Nipkow disk to produce a confocal image of the entire sample 6. This case also can provide an equivalent effect to that described in this embodiment.

Also in the other embodiments described later, NAs seemingly identical to each other in the drawing are actually different from each other, and the epi-illumination and the Nipkow disk can alternatively be used.

### Embodiment 2

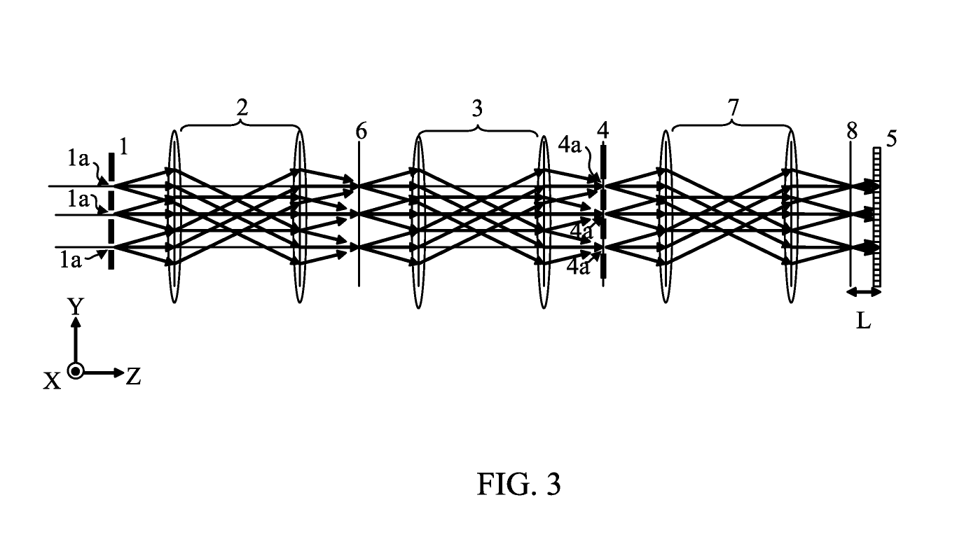

FIG. 3 illustrates a configuration of a confocal microscope that is a second embodiment (Embodiment 2) of the present invention. In this embodiment, constituent elements identical to those in Embodiment 1 are denoted by same reference numerals as those in Embodiment 1. Description will be made here mainly of differences from Embodiment 1.

In Embodiment 1, each of the response lights from the sample 6 is condensed toward each of the second pinholes 4a, and the light-receiving element 5 is disposed at the position distant from the second pinholes 4a by the first distance L. Differently therefrom, in this embodiment, each of response lights passes through each of second pinholes 4a of a second pinhole array 4 is further imaged by an imaging optical system 7, and a light-receiving element 5 is disposed at a position distant from an imaging plane 8 of the imaging optical system 7 by a first distance.

In FIG. 3, each of the illumination lights after passing through each of first pinholes 1a of a first pinhole array 1 is condensed by an illumination optical system 2 on the sample 6. Each of the response lights from the sample 6 is condensed by a condensing optical system 3 toward each of the second pinholes 4a of the second pinhole array 4. Each response light after passing through the second pinhole 4a is imaged by the imaging optical system 7 on its imaging plane 8. The light-receiving element 5 is disposed at the position distant from the imaging plane 8 by the first distance L.

In this embodiment, the first pinholes 1a, the light-condensing points on the sample 6 and the second pinholes 4a and the imaging plane 8 are optically conjugate points conjugate to one another. This optical arrangement in which the light-receiving element 5 is disposed at the position distant from the imaging plane 8 which is the conjugate point of the second pinhole 4a by the first distance causes the response light after passing through the second pinhole 4a with a spread as in Embodiment 1 to enter the multiple pixels on the light-receiving element 5. This embodiment also enables producing a confocal image with less color shift, which is similar to Embodiment 1.

The distance L and the first and second pinhole pitches s1 and s2 in this embodiment can be appropriately set by the same method as that in Embodiment 1 by regarding a combination of the condensing optical system 3 and the imaging optical system 7 shown in FIG. 3 as the condensing optical system 3 in Embodiment 1 (FIG. 1).

### Embodiment 3

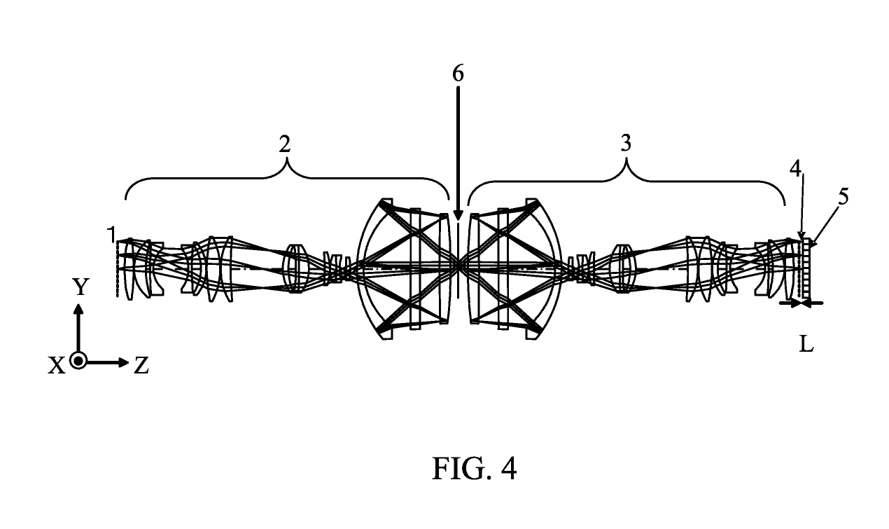

FIG. 4 illustrates, as a third embodiment (Embodiment 3) of the present invention, a more specific numerical example of the illumination optical system 2 and the condensing optical system 3 of the confocal microscope described in Embodiment 1. Also in this embodiment, constituent elements identical to those in Embodiment 1 are denoted by same reference numerals as those in Embodiment 1.

In this embodiment, the illumination optical system 2 and the condensing optical system 3 are optical systems identically configured but oppositely oriented to each other.

Table 2 shows numerical data of the condensing optical system 3. The condensing optical system 3 has a sample-side field angle that covers a range of 15 mm by 15 mm on the sample 6. In addition, an imaging magnification m2 of the condensing optical system 3 is 4×. The illumination optical system 2 has the configuration identical and oppositely oriented to the condensing optical system 3 and has an imaging magnification of ¼×. Numbers in the most left column in Table 2 denote an order of optical surfaces when counted from a sample surface side with the sample surface being zero.

In this embodiment, when NA12 and NA22 are each 0.6, Table 1 described in Embodiment 1 can be used without change, and setting each of the first and second pinhole pitches s1 and s2 to approximately 98 μm enables realizing a confocal microscope capable of providing a color confocal image with less color shift.

Moreover, in this embodiment, the sample-side field angle of the condensing optical system 3 is sufficiently large to cover the range of 15 mm by 15 mm on the sample 6, which can shorten a period of time for scanning the entire sample 6 and thus can provide a confocal image of the entire sample 6 in a short period of time.

Each of the above-described embodiments makes is possible to realize a confocal microscope capable of scanning a sample in a short period of time and of providing an image with a good image quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-001690, filed on Jan. 8, 2014, which is hereby incorporated by reference herein in its entirety.

TABLE 1

| | exp1 | exp2 | exp3 | exp4 | exp5 | exp6 | exp7 | exp8 |
|---|---|---|---|---|---|---|---|---|
| ENTRANCE-SIDE NA (NA11) | 0.15 | 0.06 | 0.024 | 0.012 | 0.006 | 0.004 | 0.003 | 0.0024 |
| EXIT-SIDE NA (NA12) | 0.6 | 0.6 | 0.6 | 0.6 | 0.6 | 0.6 | 0.6 | 0.6 |
| m1 | 0.25 | 0.1 | 0.04 | 0.02 | 0.01 | 0.006667 | 0.005 | 0.004 |
| ENTRANCE-SIDE NA (NA21) | 0.6 | 0.6 | 0.6 | 0.6 | 0.6 | 0.6 | 0.6 | 0.6 |
| EXIT-SIDE NA (NA22) | 0.15 | 0.06 | 0.024 | 0.012 | 0.006 | 0.004 | 0.003 | 0.0024 |
| m2 | 4 | 10 | 25 | 50 | 100 | 150 | 200 | 250 |
| FIRST PINHOLE RADIUS* | 1.87 | 4.675 | 11.6875 | 23.375 | 46.75 | 70.125 | 93.5 | 116.875 |
| SPOT RADIUS ON SAMPLE* | 0.4675 | 0.4675 | 0.4675 | 0.4675 | 0.4675 | 0.4675 | 0.4675 | 0.4675 |
| SECOND PINHOLE RADIUS* | 1.87 | 4.675 | 11.6875 | 23.375 | 46.75 | 70.125 | 93.5 | 116.875 |
| RIGHT SIDE OF | 97.7205 | 97.7205 | 97.7205 | 97.7205 | 97.7205 | 97.7205 | 97.7205 | 97.7205 |
| EXPRESSION (9)* | | | | | | | | |
| DISTANCE BETWEEN SPOTS | 24.43013 | 9.77205 | 3.90882 | 1.95441 | 0.977205 | 0.65147 | 0.488603 | 0.390882 |
| ON SAMPLE CALCULATED | | | | | | | | |
| FROM EXPRESSION (9)* | | | | | | | | |
| RIGHT SIDE OF | 3.74 | 9.35 | 23.375 | 46.75 | 93.5 | 140.25 | 187 | 233.75 |
| EXPRESSION (11)* | | | | | | | | |
| DISTANCE BETWEEN SPOTS | 0.935 | 1.16875 | 1.16875 | 1.16875 | 1.16875 | 1.16875 | 1.16875 | 1.16875 |
| ON SAMPLE CALCULATED | | | | | | | | |
| FROM EXPRESSION (11)* | | | | | | | | |
| MINIMUM DISTANCE | 97.7205 | 97.7205 | 97.7205 | 97.7205 | 97.7205 | 140.25 | 187 | 233.75 |
| BETWEEN SECOND | | | | | | | | |
| PINHOLES* | | | | | | | | |
| MINIMUM DISTANCE | 24.43013 | 9.77205 | 3.90882 | 1.95441 | 0.977205 | 0.935 | 0.935 | 0.935 |
| BETWEEN SPOTS ON | | | | | | | | |
| SAMPLE* | | | | | | | | |
| MINIMUM DISTANCE | 52.25695 | 20.90278 | 8.361113 | 4.180556 | 2.090278 | 2 | 2 | 2 |
| BETWEEN SPOTS/ | | | | | | | | |
| DIAMETER OF SPOT | | | | | | | | |
| ON SAMPLE | | | | | | | | |
| DISTANCE BETWEEN | 325.735 | 814.3375 | 2035.844 | 4071.688 | 8143.375 | 12215.06 | 16286.75 | 20358.44 |
| SECOND PINHOLE AND | | | | | | | | |
| LIGHT-RECEIVING | | | | | | | | |
| ELEMENT* | | | | | | | | |

*UNIT: μm
OTHERS ARE DIMENSIONLESS NUMBERS

TABLE 2

| | | | REFRACTIVE | | |
|---|---|---|---|---|---|
| | R | DISTANCE | INDEX | ABBE NUMBER | |
| 0 | INFINITY | 13.39 | | | OBJECT SURFACE |
| | | | | | (SAMPLE SURFACE) |
| 1 | 819.00 | 16.40 | 1.487 | 70.24 | |
| 2 | −3201.41 | 28.35 | | | |
| 3 | INFINITY | 13.97 | 1.487 | 70.24 | |
| 4 | INFINITY | 68.55 | | | |
| 5 | −122.05 | 9.54 | 1.517 | 52.43 | |
| 6 | −172.82 | −9.54 | 1.517 | 52.43 | REFLECTION |
| 7 | −122.05 | −68.55 | | | |
| 8 | INFINITY | −13.97 | 1.487 | 70.24 | |
| 9 | INFINITY | −28.35 | | | |
| 10 | −3201.41 | −16.40 | 1.487 | 70.24 | REFLECTION |
| 11 | 819.00 | 16.40 | 1.487 | 70.24 | |
| 12 | −3201.41 | 28.35 | | | |
| 13 | INFINITY | 13.97 | 1.487 | 70.24 | |
| 14 | INFINITY | 68.55 | | | |
| 15 | −122.05 | 9.54 | 1.517 | 52.43 | |
| 16 | −172.82 | 10.00 | | | |
| 17 | 126.58 | 6.22 | 1.744 | 44.85 | |
| 18 | −950.12 | 9.32 | | | |
| 19 | −64.86 | 5.00 | 1.681 | 31.36 | |
| 20 | 537.54 | 8.74 | 1.620 | 60.32 | |
| 21 | −56.79 | 0.50 | | | |
| 72 | 82.22 | 7.50 | 1.487 | 70.41 | |
| 23 | 635.34 | 23.00 | | | |
| 24 | 64.84 | 14.27 | 1.690 | 49.87 | |
| 25 | 618.89 | 5.01 | 1.755 | 27.58 | |
| 26 | 709.49 | 10.48 | | | |
| 27 | −96.82 | 8.38 | 1.744 | 34.46 | |
| 28 | −68.50 | 76.14 | | | |
| 29 | −577.36 | 14.75 | 1.744 | 44.85 | |
| 30 | −104.66 | 0.50 | | | |
| 31 | 116.63 | 19.70 | 1.744 | 44.85 | |
| 32 | −222.26 | 0.50 | | | |
| 33 | 65.69 | 7.94 | 1.755 | 27.58 | |
| 34 | 70.78 | 13.16 | | | |
| 35 | −483.66 | 5.00 | 1.736 | 28.39 | |
| 36 | 53.97 | 51.45 | | | |
| 37 | −43.90 | 5.00 | 1.616 | 36.83 | |
| 38 | −429.14 | 6.13 | | | |
| 39 | −138.51 | 17.04 | 1.744 | 44.50 | |
| 40 | −58.87 | 0.50 | | | |
| 41 | 357.86 | 13.06 | 1.744 | 44.85 | |
| 42 | −313.15 | 10.50 | | | |
| 43 | INFINITY | | | | IMAGING PLANE |
| | | | | | (SECOND PINHOLE) |

What is claimed is:

1. A confocal microscope comprising:
a first pinhole array provided with multiple first pinholes;
an illumination optical system configured to introduce multiple light fluxes after passing through the multiple first pinholes to a sample;
a condensing optical system configured to condense each of the multiple light fluxes from the sample;
a second pinhole array provided with multiple second pinholes through which the multiple light fluxes from the condensing optical system respectively pass; and
a light-receiving element configured to receive the multiple light fluxes after passing through the multiple second pinholes,
wherein the light-receiving element is disposed at a position distant, by a first distance, from each of the second pinholes or from a conjugate point of each of the second pinholes and is configured to receive, at multiple pixels, each of the light fluxes after passing through the second pinholes.

2. A confocal microscope according to claim 1, wherein each of the light fluxes after passing through the second pinholes enters the multiple pixels as a light flux having a spread depending on the first distance.

3. A confocal microscope according to claim 2, wherein the multiple pixels include color filters configured to cause lights in mutually different wavelength ranges to pass therethrough.

4. A confocal microscope according to claim 1, wherein the following relation is established:
N=π·[(L·NA22)/p]²
where NA22 represents a numerical aperture of each light flux condensed from the condensing optical system toward the second pinhole, L represents the first distance, p represents a pixel pitch of the light-receiving element, and N represents number of pixels on the light-receiving element which receive the light flux after passing through each of the second pinholes.

5. A confocal microscope according to claim 4, wherein the following conditions are satisfied:
s2>2·NA22·L
r2=k2·λ/NA22
s2>2·k2·λ/NA22
where r2 represents a radius of the second pinhole, s2 represents a center-to-center distance between two mutually adjacent second pinholes of the second pinhole array, λ represents a wavelength of the light fluxes, and k2 represents a constant.

6. A confocal microscope according to claim 1, wherein the condensing optical system has a sample-side field angle covering the sample whose size is at least 15 mm by 15 mm.
